(19) United States
(12) Patent Application Publication
(10) Pub. No.: US 2010/0282853 A1
(43) Pub. Date: Nov. 11, 2010

(54) HOLDER FOR READER AND PACKAGE

(75) Inventors: Marcus Dehlin, Hammaro (SE); Ingrid Rokahr, Karlstad (SE)

Correspondence Address: GREER, BURNS & CRAIN, 300 S WACKER DR, 25TH FLOOR, CHICAGO, IL, 60606, US

(73) Assignee: STORA ENSO OYJ, Helsinki (FI)

(21) Appl. No.: 12/740,442

(22) PCT Filed: Nov. 5, 2008
(86) PCT No.: PCT/SE2008/000627

§ 371 Date: Apr. 29, 2010

Related U.S. Application Data
(60) Provisional application No. 61/002,035, filed on Nov. 5, 2007.

(51) Int. Cl. G06K 7/00

(52) U.S. Cl. 235/486

(57) ABSTRACT

The disclosure relates to a holder (1) including means (5) for holding a reader (4) and means (3) for holding a package, wherein the holder (1) is adapted to position said package relative to said reader (4) allowing information stored in a memory of the package to be read out by the reader (4).

### FIELD OF THE INVENTION

The invention relates to a holder. The holder may be used to facilitate secure transfer of data (such as compliance data) stored in a memory of a package to a reader.

### BACKGROUND TECHNOLOGY

In order to improve the efficiency of medication, the compliance with the prescription scheme is of importance. Technology has been developed to detect and log the removal of tablets from packages. Examples of such packages are blister packages that monitor when a pill is pushed through a backing foil of a blister. A blister pack allows the registration of the removal of a dose of use. The log is stored in a memory device integrated in the package, for example in the blister card, or in the package containing the blister card. When the package is taken to a reading device, the compliance data stored in the memory can be transferred to the reader and further on to a computer. The compliance data log can be used to analyse the patient's compliance with the prescription or to record the medication time stamps to follow up in the need of certain medication. In both cases the compliance control is used instead of a diary. In order to make such a solution work, it is essential that it is easy for a user to collect the information monitored by the package. It is therefore of importance that the package comprising the monitor and the reader is well suited to make the reading of the data possible.

The equipment used for storing the compliance data in a package comprises an electronic module connected to a printed antenna. The electric module comprises means for data storage, data processing and for receiving information from sensors connected to the electronic module. The module is normally powered by a battery. The antenna is often made of two symmetric conductive fields, preferably of printed carbon. The reader has similar conductive areas and in order to be able to read out information from the package via capacitive coupling, the two fields of the antenna on the package must overlap with the corresponding fields of the reader, i.e. the alignment and the orientation of the reader and the package are most important for the communication between the reader and the package. Alternative solutions are known which use antennae for RFID and inductive coupling or information transfer by direct contact but antenna with capacitive coupling is currently the most common one.

### SUMMARY OF THE INVENTION

The invention relates to a holder including means for holding a reader and means for holding a package, wherein the holder is adapted to position said package relative to said reader allowing information stored in a memory of the package to be read out by the reader.

The holder will provide that the package is placed in the correct place and correct orientation related to the reading device so that the antennae of the reader and the packages are overlapping. Also, by having the reader in a holder, and by adapting the holder to the size and appearance of the package, the same reader can be used independently for various package formats, as long as the antenna of the reader and the antenna of the package are having about the same size. The holder can be flexible making it fit differently sized packages. Another embodiment of the invention is to custom made the holder to fit one package, i.e. only a package with right size and form will be fit in the holder. Today it is necessary to make the readers in different sizes in order to make them suitable for different packages. Thus, the present invention is very cost saving for the production of readers since the need for producing different sizes of readers will be decreased. Thus, bigger volumes of the reader can be produced and serve many different sized packages. In addition the format parts for making different plastic shells for the reader are very costly and may many times contribute negatively to the cost-benefit analysis, when customers need or would prefer a customized suitable reader for their product. One advantage of providing a holder is that a reader device of fixed size can easily be adapted to fit several package sizes and still making it easy to align package and reader antennae. The benefit is to provide a user-friendly customized reader at neglectable additional cost and on very short notice.

Another benefit by minimizing the number of different readers is to avoid extra cost for doing the required CE (Communauté Européenne) certification for product safety. By introducing the CE approved plastic covered reader into the holder no extra certification is required to put the product on the market hence saving cost, minimizing risks for the user and making time to market much shorter than the designs available today.

In one preferred embodiment the holder is formed of at least two portions, a first portion being adapted to hold the reader and a second portion being adapted to hold the package. The two portions may either be on opposite sides of one panel of the holder or the holder may consist of two separate parts that are put together.

In one preferred embodiment the reader comprises means for reading out information comprising an antenna adapted to be capacitively coupled to an antenna in the package.

In one preferred embodiment the holder is provided with information, such as printed or tactile information, adapted to guide the user when positioning a package in said holder. For example, instructions regarding the right alignment and position of the package in the holder can be printed on the holder. The holder can also be printed with an image of the package so that the user would lay the package down as the printed image shows. Instructions may also be written to the user making it clear how the user should position the package in the holder. This is of importance in order to position the package antenna over the reader antenna. A normal rectangular package would geometrically allow four different positions (switching left and right side, and turning upside down), of which only one is working properly for information transfer. This instruction can be given easily to the user by printing the image of the package or other information on the holder, which may be board-based.

It is also possible to use the holder for providing area for advertisements. The advertisements printed on the holder can be used to finance the reading device for the user. It can also be useful to print the prescription scheme or other relevant information for the patient on the holder.

Braille is nowadays required on pharmaceutical packaging in many countries throughout the world. Equally important is of course to communicate with Braille on all equipment being used in combination to the pharmaceutical package. Thus, it is possible to provide the holder with Braille.

In one preferred embodiment the holder further comprises a device for wireless charging of a battery contained in said package. The battery powers the electric module and thus the compliance monitoring means. This would prolong the life time of a compliance monitoring package. In case a used blister card is exchangeable with a new one (also having sensors for detecting when a blister has been opened), the same electronics could be used for a series of blister packs. The power for the charging device could be obtained from solar energy, integrated fuel cells or electrolytic cells, or from a computer connected to the reader. The charging device could also be connected to an external power supply via a cable.

In one preferred embodiment the holder further comprises an integrated or printed display adapted to provide information to a user. The integrated or printed display may be used to provide analysis results or other variable information to the user. The display may also be external, such as for example a computer monitor, a PDA or a mobile telephone. In case the holder is also used for storing the package between the tablet removal events, the reader could carry a reminder function making the user aware of when a medicament should be taken.

In one preferred embodiment the holder is made of paper or board. The use of a paper or board based holder has a positive environmental effect in a Life Cycle Assessment (LCA). The board material can be made of recycled material. Also, the format parts for the reader can be kept at a minimum hence using less plastic for reaching different sizes depending of the package in focus. Another advantage with a board based holder is that it is very easy to provide the holder with the appropriate information, i.e. by printing.

In one preferred embodiment the reader is releasable attachable to the holder. This makes it possible to reuse the reader in another holder. Thus, this provides the possibility for the user to, after finishing a therapy, return the complete holder including the reader to the market place where the reader will be separated from the holder and reused for another product. The holder made of board can go into recycling. The reader can then be reused for a similar kind of holder or introduced into another sized/printed holder for a different product.

### BRIEF DESCRIPTION OF THE FIGURES

The invention will by way of example be described in more detail with reference to the appended schematic drawings, which shows a presently preferred embodiment of the invention.

FIG. 1 shows the assembly of a holder comprising a reader.

FIG. 2 shows a holder comprising a reader.

FIG. 3 shows a package being presented to the holder. The package is adapted to be turned with the antenna facing the reader hidden inside the holder.

FIG. 4 shows a holder together with the package.

### DETAILED DESCRIPTION OF A PREFERRED EMBODIMENT

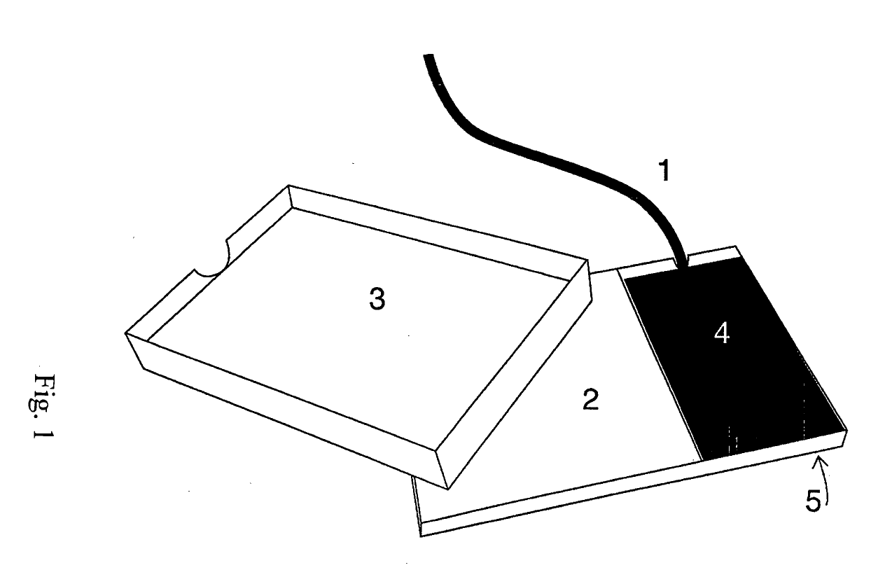

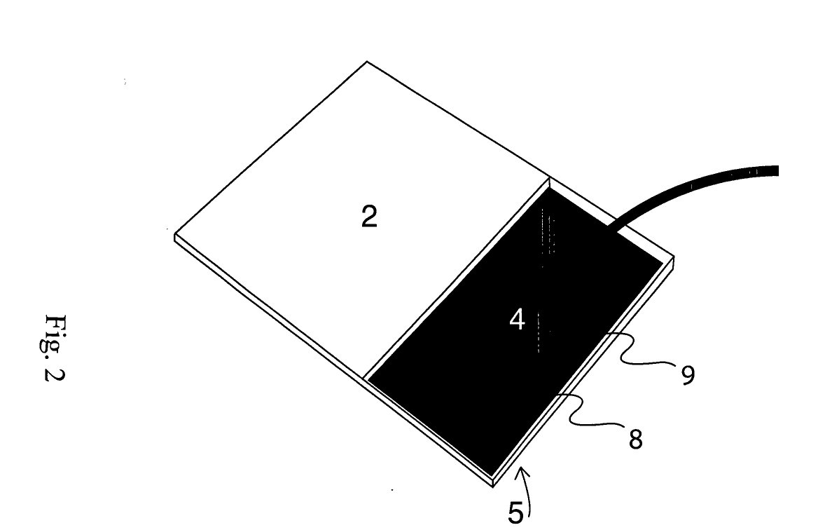

With reference to FIG. 1 and FIG. 2; the holder 1 comprises two parts 2, 3; a first part 2 that contains the reader 4 and a second part 3 adapted to receive a package 6. The reader 4 is placed in a specially adapted spacing 5 in the first part 2 of the holder 1. The spacing 5 is adapted to hold the reader 4 in a way that the reader 4 is steadily kept in place. The reader 4 is releasable attachable to the holder 1.

The two parts 2, 3 of the holder 1 are put together so that the reader 4 is protected and does not fall out from its spacing 5. The second part 3 extends over the spacing 5 and the reader 4 located in said spacing 5.

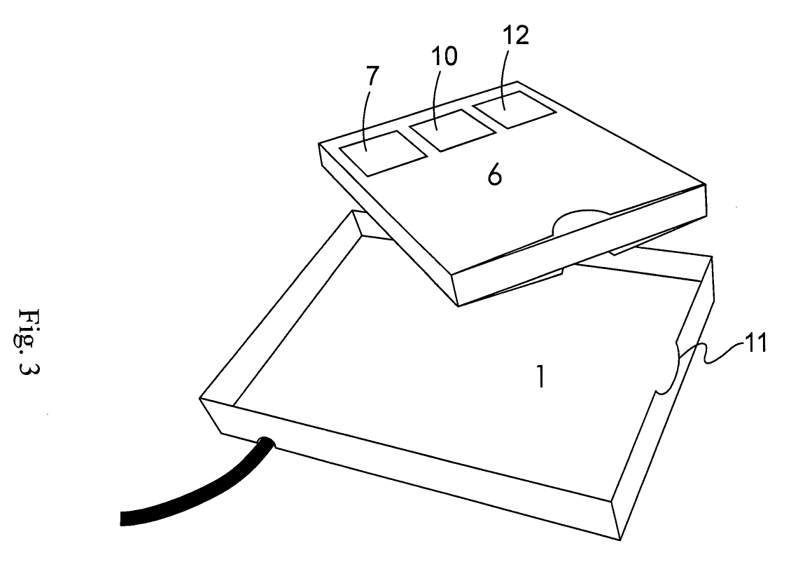

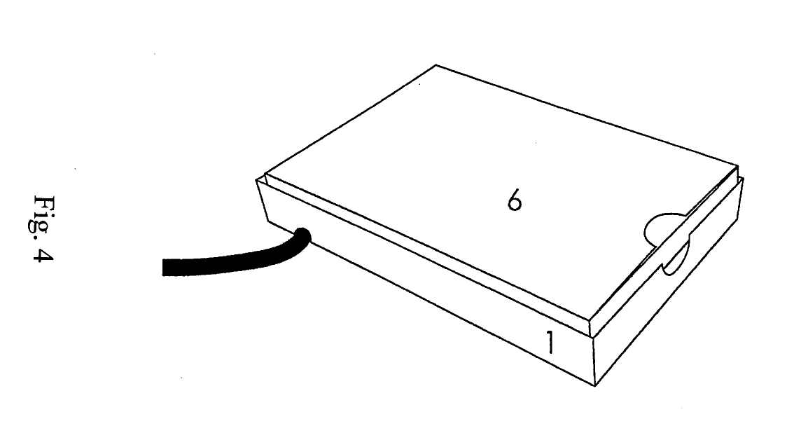

FIG. 3 shows a package 6 and the holder 1 containing the reader 4. The package 6 is adapted to fit into the holder, as can be seen in FIG. 4, i.e. into the second part 3 of the holder 1, wherein the package 6 is placed so that the antenna 10 (schematically shown) is in accurate place compared to antenna 8 of the reader 4 so that the reader 4 is able to read out the information stored in a memory 7 (schematically shown) in the package 6.

The second part 3 of the holder 1 can be made in any form and size in order to fit the package 6. The reader 4 is placed in the holder 1 so the antennas of the reader 4 and the package 6 are located above each other making it possible to read out the information.

The holder 1 is provided with information, such as printed or tactile information, adapted to guide the user when positioning a package 6 in said holder 1. For example, the cut-out 11 in the holder 1 may be used to provide information that the similarly cut cut-out in the package 6 should be directed in the same direction.

The holder 1 further comprises a device 9 for wireless charging of a battery 12 (schematically shown) contained in said package 6. The device 9 may be integrally formed with the reader 4 or be arranged as a separate part. The device 9 is arranged in the spacing 5.

The holder 1 further comprises an integrated or printed display (not shown) adapted to provide information to a user. The holder 1 may also comprise an external displeay such as a computer monitor (not shown), a PDA (not shown) or a mobile phone (not shown).

In use there is no struggle when trying to read out the information from the package, i.e. to place the package in the correct position so that the antennae of the reader and the package are correctly aligned. Also, the holder can be adapted to any form and size while the size of the reader can be the same or it can be reduced to a limited number of formats. Thus, the holder is very user-friendly and it ensures reliable data exchange with the package.

In the preferred embodiment the holder is made of paper or board. Paper and board are foldable and therefore it is easy to form a three-dimensional holder from a two-dimensional sheet. The sheet is preferably having creased lines to enable the correct folding and a graphical print to support the user in folding the holder and in placing the package in the correct orientation.

A patient having a reader at home for the use of reading information from pharmaceutical packages with compliance monitoring functions can get a sheet for do-it-yourself-assembly of a holder. A user could also download the right layout from Internet and print it on stiffer paper or an outer board-wrap of the package can be used or be modified as a holder.

The reader comprises means for reading out information and the package comprises means for storing information and communicating information to the reader. Examples of such compliance control packages are described in U.S. Pat. No. 6,244,462 and US2005/122219. The means for reading out information consist preferably of an antenna in the package which is capacitively coupled to an antenna in the reader. The means for storing information consists preferably of an electric module connected to a printed antenna, preferably printed carbon antenna.

1. Holder including means for holding a reader and means for holding a package, wherein the holder is adapted to position said package relative to said reader allowing information stored in a memory of the package to be read out by the reader.

2. Holder according to claim 1, wherein the holder is formed of at least two portions, a first portion being adapted to hold the reader and a second portion being adapted to hold the package.

3. Holder according to claim 1, wherein the reader comprises means for reading out information comprising an antenna adapted to be capacitively coupled to an antenna in the package.

4. Holder according to claims 1, the holder further being provided with printed or tactile information, adapted to guide the user when positioning a package in the holder.

5. Holder according to claim 1, wherein the holder further comprises a device for wireless charging of a battery contained in said package.

6. Holder according to claim 1, wherein the holder further comprises an integrated or printed display adapted to provide information to a user.

7. Holder according to claim 1, wherein the holder is made of paper or board.

8. Holder according to claim 1, wherein the reader is releasable attachable to the holder.

9. A holder for receiving a reader and a package having a memory, the holder comprising a fist part adapted for holding a reader and a second part adapted for receiving the package relative to the reader so that information stored in the package memory can be read by the reader.

10. A holder for receiving a package having a memory, an antenna and a battery, the holder comprising:
a first holder portion,
a reader having an antenna held in the first holder portion,
a wireless charging device held in the first holder portion, and
a second holder portion adapted to hold the package and orientate the package so that the package antenna and reader antenna are above each other and so that the charging device is wirelessly connected to the package battery.
